(19) United States
(12) Patent Application Publication
(10) Pub. No.: US 2005/0072520 A1
(43) Pub. Date: Apr. 7, 2005

(54) Paper-like precious metal medium of exchange

(76) Inventor: Eugene Berman, Gibbstown, NJ (US)

Correspondence Address: Donald J. Ersler, 725 Garvens Avenue, Brookfield, WI, 53005, US

(21) Appl. No.: 10/678,481

(22) Filed: Oct. 2, 2003

(51) Int. Cl. C09J 1/00; B32B 31/00; B41M 1/00

(52) U.S. Cl. 156/276; 156/277; 156/300

(57) ABSTRACT

A paper-like precious metal medium of exchange includes a quantity of precious metal retained between two protective layers. The precious metal may be gold, sliver, platinum or any other precious metal. The precious metal is applied to at least one of the protective layers with any suitable deposition process. If the substrate is used, the substrate is retained between the two protective layers. A protective pocket could replace the two protective layers. The precious metal in a solid form, particle form or retained by a substrate would be inserted into an open end of a inner compartment. Each protective layer or the protective pocket is preferably fabricated from a thin plastic material that has a high degree of durability. The two protective layers are joined to each other using any suitable process such as adhesive or sonic welding. The open end of the inner compartment is sealed.

### BACKGROUND OF THE INVENTION

1. Field of the Invention

The present invention relates generally to mediums of exchange and more specially to a paper-like precious metal medium of exchange, containing the full value of the precious metal.

2. Discussion of the Prior Art

All world currencies are inconvertible. That is to say, there is no obligation to exchange or redeem that currency for any other thing of specific value nor any representation as to its purchasing power, other than that determined on the market. Precious metals (especially gold and silver) have been used as mediums of exchange since antiquity, either in bulk forms such as bullion bars or in smaller forms, primarily coins, meant for ordinary use in everyday life, such as in making payment for purchases or saving for payments anticipated in the future. In circulation, precious-metal coins have certain handling disadvantages, chief among which is being subject to loss of value through normal wear, from damage, and by fraudulent action (“clipping,” debasement, etc.).

Two other currency-related forms are disclosed in U.S. Pat. No. 3,950,015 to Shrock and U.S. Pat. No. 5,671,364 to Turk. The Schrock patent discloses a negotiable instrument and the Turk patent discloses a method and systems for commodity based currency for payment of accounts and elimination of payment risk. The Schrock patent includes a negotiable instrument similar to a conventional travelers cheque, but distinguishable in several important details. The Turk patent includes a system and method for permitting gold or other commodities to circulate as currency requires a network of system users that participate in financial transactions where payment is made in units of gold.

However, neither of these patents considered involve a physically-transferrable medium of exchange in and of itself composed of the precious metal, comprising the value being used in the exchange and wholly independent of any intermediary redemption or storage agency. The word “note” used herein is merely used to refer to the physical form of the paper currency familiar to nearly everyone and not to any of the technical definitions referring to its promissory quality.

Accordingly, there is a clearly felt need in the art for a paper-like precious metal medium of exchange, which includes a denomination describing the value of the note based on the type and amount of precious metal contained therein and does not require an account or system to provide value to the note.

### SUMMARY OF THE INVENTION

The present invention provides a paper-like precious metal medium of exchange having the value of the precious metal contained therein. The paper-like precious metal medium of exchange (precious metal note) includes a quantity of precious metal retained between two protective layers. The precious metal may be gold, sliver, platinum, palladium, rhodium, iridium, osmium or any other precious metal. The precious metal is applied to at least one of the protective layers or a substrate using sputtering, vacuum deposition, electrolysis or any other suitable deposition process. The precious metal may also be embedded in the substrate. The precious metal may also be suspended in a paint-like coating and sprayed on to the at least one protective layers or the substrate. If the substrate is used, the substrate is retained between the two protective layers and must be thin and flexible. A protective pocket could replace the two protective layers. The precious metal in a solid form, particle form or on a substrate would be inserted into an open end of an inner compartment in the protective pocket.

Each protective layer or protective pocket is preferably fabricated from a thin plastic material that has a high degree of durability. The two protective layers are joined to each other using any suitable process such as adhesive or sonic welding. The open end of the protective pocket is sealed using any suitable process such as adhesive or sonic welding. The precious metal note is preferably the same size and shape of existing paper currencies, but could be any other appropriate size or shape. The precious metal note preferably includes an identification (such as a denomination) of the type and amount of precious metal. It is also preferable that the precious metal note include an anti-counterfeiting measure, such as a hologram. The precious metal note would be sold at a premium to its value to pay for the costs of production, authentication, fluctuations in value and other costs.

Accordingly, it is an object of the present invention to provide a precious metal note having a denomination describing the value of the note based on the type and amount of precious metal contained therein.

Finally, it is another object of the present invention to provide a precious metal note, which does not require an account, institution, agency, or system to provide value to the note.

These and additional objects, advantages, features and benefits of the present invention will become apparent from the following specification.

### BRIEF DESCRIPTION OF THE DRAWINGS

FIG. 1 is an exploded perspective view of a precious metal note in accordance with the present invention.

FIG. 2 is an enlarged front cross sectional view of a precious metal note in accordance with the present invention.

FIG. 3 is an exploded perspective view of a second embodiment of a precious metal note in accordance with the present invention.

FIG. 4 is an enlarged front cross sectional view of a second embodiment of a precious metal note in accordance with the present invention.

FIG. 5 is an exploded perspective view of a third embodiment of a precious metal note in accordance with the present invention.

FIG. 6 is an enlarged front cross sectional view of a third embodiment of a precious metal note in accordance with the present invention.

FIG. 7 is a perspective view of a precious metal note with a denomination and hologram in accordance with the present invention.

### DETAILED DESCRIPTION OF THE PREFERRED EMBODIMENTS

With reference now to the drawings, and particularly to FIG. 1, there is shown an exploded perspective view of a precious metal note 1. With reference to FIG. 2, the precious metal note 1 includes a quantity of precious metal 10 retained between a first protective layer 12 and a second protective layer 14. The precious metal 10 is applied to at least one of the protective layers. Preferably, the precious metal 10 is applied to only a portion of the at least one protective layer; such that a border 16 is created around the second protective layer 14 without any precious metal 10 applied thereto. The precious metal 10 may be gold, sliver, platinum, palladium, rhodium, iridium, osmium or any other precious metal. The precious metal 10 is applied to the at least one protective layer with sputtering, vacuum deposition, electrolysis or any other suitable deposition process. The precious metal 10 may also be suspended in a paint-like coating and sprayed on to the at least one protective layer.

Each protective layer is preferably fabricated from a thin plastic material. The thin plastic material preferably has a high degree of durability; resistance to damage by impact, bending, tearing, abrasion, and resistance to damage from environmental degrading agents, such as acids, bases, solvents, bacteria, fungus and ultraviolet light. The first and second protective layers are joined to each other using any suitable process such as heat fusion, application of solvent, application of adhesive or sonic welding.

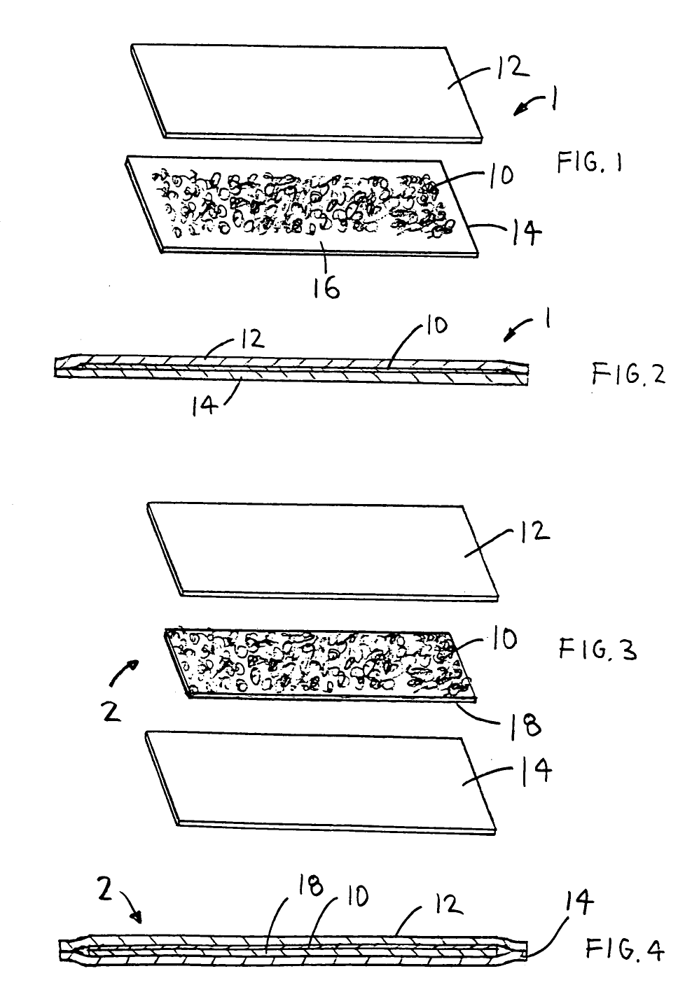

With reference to FIGS. 3-4, the precious metal 10 is applied to a substrate 18. The substrate 18 is captured between the first and second protective layers. The substrate 18 must be thin and flexible, similar to the first and second protective layers. The substrate 18 could be fabricated from the same material as the first and second protective layers, but may be fabricated from a less expensive material to reduce cost. The precious metal 10 may also be embedded in the substrate 18. In example, becoming an integral portion of the substrate 18.

With reference to FIGS. 5-6, a protective pocket 20 replaces the first and second protective layers. The protective pocket 20 includes an inner compartment 21 with an open end 24. The precious metal 10 is inserted into the open end 24 of the inner compartment 21 in the form of a solid 22, particles or retained by the substrate 18. The open end 24 of the protective pocket 20 is sealed with any suitable method, such as heat fusion, application of solvent, application of adhesive or sonic welding. The protective pocket 20 is preferably fabricated from the same material as the first and second protective layers. The protective pocket 20 may be fabricated by any suitable manufacturing process.

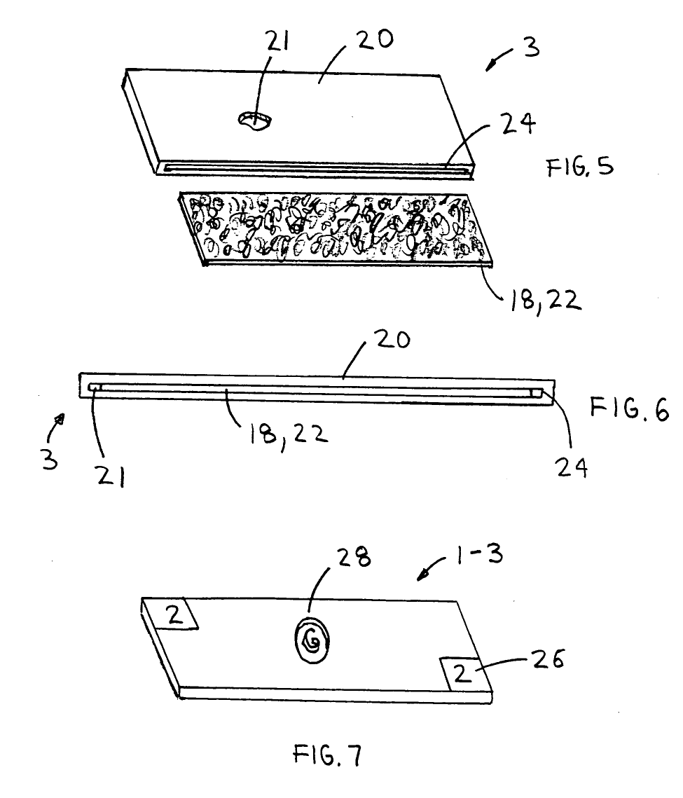

The thickness of the precious metal note 1-3 is preferably 0.005 inches thick or less to be light weight and flexible. However, the precious metal note 1-3 could be as thick as 0.020 inches. The precious metal note 1-3 is preferably the same size and shape of existing paper currencies, but could be any other appropriate size or shape. With reference to FIG. 7, the precious metal note 1-3 preferably includes an identification of the type and amount of precious metal contained therein. The identification could be a denomination 26 in the form of a “2” to signify two grams of precious metal. It is also preferable that the precious metal note include an anti-counterfeiting measure, such as a hologram 28. The hologram 28 could include the type of metal, such as a “G” for gold. Anti-counterfeiting measures are well known in the art and need not be explained in detail.

A color code may be used to provide differentiation between the type of precious metal and/or the weight of the precious metal. Different patterns or designs could also be employed to provide differentiation between the type of precious metal and/or the weight of the precious metal. The precious metal note 1-3 would be sold at a premium to its value to pay for the costs of production, authentication, fluctuations in value and other costs. The precious metal note 1-3 would have a value of substantially the precious metal contained therein. Extra value may be applied due to the premium of the cost of manufacture.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

1. A method of providing a paper-like precious metal medium of exchange, comprising the steps of:
providing a first protective layer and a second protective layer;
retaining a quantity of precious metal between said first protective layer and said second protective layer; and
attaching said first protective layer to said second protective layer, wherein said paper-like precious metal medium of exchange having at least the value of the precious metal contained therein.

2. The method of providing a paper-like precious metal medium of exchange of claim 1, further comprising the step of:
providing said paper-like precious metal medium of exchange with a thickness of no greater than 0.020 inches.

3. The method of providing a paper-like precious metal medium of exchange of claim 1, further comprising the step of:
applying said quantity of precious metal to a substrate, retaining said substrate between said first protective layer and said second protective layer.

4. The method of providing a paper-like precious metal medium of exchange of claim 1, further comprising the step of:
embedding said quantity of precious metal in a substrate, retaining said substrate between said first protective layer and said second protective layer.

5. The method of providing a paper-like precious metal medium of exchange of claim 1, further comprising the step of:
applying an anti-counterfeiting measure to said paper-like precious metal medium of exchange.

6. The method of providing a paper-like precious metal medium of exchange of claim 1, further comprising the step of:
applying a color code to said paper-like precious metal medium of exchange to differentiate value or the type of precious metal.

7. The method of providing a paper-like precious metal medium of exchange of claim 1, further comprising the step of:
applying a denomination marking to said paper-like precious metal medium of exchange to differentiate value or the type of precious metal.

8. A method of providing a paper-like precious metal medium of exchange, comprising the steps of:
providing a first protective layer and a second protective layer;
applying said quantity of precious metal to a substrate, retaining said substrate between said first protective layer and said second protective layer; and
attaching said first protective layer to said second protective layer, wherein said paper-like precious metal medium of exchange having at least the value of the precious metal contained therein.

9. The method of providing a paper-like precious metal medium of exchange of claim 8, further comprising the step of:
providing said paper-like precious metal medium of exchange with a thickness of no greater than 0.020 inches

10. The method of providing a paper-like precious metal medium of exchange of claim 8, further comprising the step of:
applying an anti-counterfeiting measure to said paper-like precious metal medium of exchange.

11. The method of providing a paper-like precious metal medium of exchange of claim 8, further comprising the step of:
applying a color code to said paper-like precious metal medium of exchange to differentiate value or the type of precious metal.

12. The method of providing a paper-like precious metal medium of exchange of claim 8, further comprising the step of:
applying a denomination marking to said paper-like precious metal medium of exchange to differentiate value or the type of precious metal.

13. A method of providing a paper-like precious metal medium of exchange, comprising the steps of:
providing a protective pocket having an inner compartment with an open end;
inserting a quantity of precious metal into said inner compartment; and
sealing an open end of said inner compartment, wherein said paper-like precious metal medium of exchange having at least the value of the precious metal contained therein.

14. The method of providing a paper-like precious metal medium of exchange of claim 13, further comprising the step of:
providing said paper-like precious metal medium of exchange with a thickness of no greater than 0.020 inches.

15. The method of providing a paper-like precious metal medium of exchange of claim 13, further comprising the step of:
applying said quantity of precious metal to a substrate, retaining said substrate in said inner compartment.

16. The method of providing a paper-like precious metal medium of exchange of claim 13, further comprising the step of:
embedding said quantity of precious metal in a substrate, retaining said substrate between said first protective layer and said second protective layer.

17. The method of providing a paper-like precious metal medium of exchange of claim 13, further comprising the step of:
applying an anti-counterfeiting measure to said paper-like precious metal medium of exchange.

18. The method of providing a paper-like precious metal medium of exchange of claim 13, further comprising the step of:
applying a color code to said paper-like precious metal medium of exchange to differentiate value or the type of precious metal.

19. The method of providing a paper-like precious metal medium of exchange of claim 13, further comprising the step of:
applying a denomination marking to said paper-like precious metal medium of exchange to differentiate value or the type of precious metal.
